(19) United States
(12) Patent Application Publication
(10) Pub. No.: US 2026/0095964 A1
(43) Pub. Date: Apr. 2, 2026

(54) PAIRING OF DEVICES USING A GRAPHICAL USER INTERFACE

(71) Applicant: Lenovo (United States) Inc., Morrisville, NC (US)

(72) Inventors: Wenyu Du, Beijing (CN); Rod D. Waltermann, Rougemont, NC (US); Jung Hwan Hong, Cary, NC (US); Christopher Smith, Franklinton, NC (US); Julia Young, Raleigh, NC (US)

(21) Appl. No.: 18/902,646

(22) Filed: Sep. 30, 2024

(51) Int. Cl. H04W 76/14; G06F 3/0481

(52) U.S. Cl. CPC H04W 76/14; G06F 3/0481

(57) ABSTRACT

One embodiment provides a device, including: receiving, at a device pairing system associated with an information handling device, an indication for pairing at least one additional device to the information handling device; presenting, on the display of the information handling device and in response to receiving the indication, a graphical user interface associated with the pairing, wherein the presenting comprises displaying a pairing indicator on the display of the information handling device; receiving, within the graphical user interface, a pairing input based upon movement of the pairing indicator from a user at the information handling device; and pairing, based upon the pairing input, the information handling device and the at least one additional device. Other aspects are claimed and described.

### BACKGROUND

Multiple monitor setups for workstations have become common in the workplace. The use of multiple displays allows a user to view more information at a time and reduces the amount of time that a user has to spend opening windows to view additional information. In both business and entertainment, the ability to view more information simultaneously makes for a smoother and more efficient operation. While traditionally multiple displays has included multiple stand-alone displays or a stand-alone display and a display associated with a device, current solutions allow users to use displays from multiple devices. Technology allows a user to connect devices so that the devices will communicate with each other, thereby allowing the user to use displays of the devices together.

### BRIEF SUMMARY

In summary, one aspect provides a method, including: receiving, at a device pairing system associated with an information handling device, an indication for pairing at least one additional device to the information handling device; presenting, on the display of the information handling device and in response to receiving the indication, a graphical user interface associated with the pairing, wherein the presenting comprises displaying a pairing indicator on the display of the information handling device; receiving, within the graphical user interface, a pairing input based upon movement of the pairing indicator from a user at the information handling device; and pairing, based upon the pairing input, the information handling device and the at least one additional device.

Another aspect provides a system, the system including: a processor; a memory device that stores instructions that, when executed by the processor, causes the system to: receive, at a device pairing system associated with the information handling device, an indication for pairing at least one additional device to the information handling device; present, on the display of the information handling device and in response to the receiving the indication, a graphical user interface associated with the pairing, wherein the presenting comprises displaying a pairing indicator on the display of the information handling device; receive, within the graphical user interface, a pairing input based upon movement of the pairing indicator from a user at the information handling device; and pair, based upon the pairing input, the information handling device and the at least one additional device.

A further aspect provides a product, the product including: a computer-readable storage device that stores executable code that, when executed by a processor, causes the product to: receive, at a device pairing system associated with an information handling device, an indication for pairing at least one additional device to the information handling device; present, on a display of the information handling device and in response to the receiving the indication, a graphical user interface associated with the pairing, wherein the presenting comprises displaying a pairing indicator on the display of the information handling device; receive, within the graphical user interface, a pairing input based upon movement of the pairing indicator from a user at the information handling device; and pair, based upon the pairing input, the information handling device and the at least one additional device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for pairing an information handling device to at least one additional device by use of a device pairing system.

FIG. 4 illustrates an example pairing graphical user interface as initially presented on an information handling device.

FIG. 5 illustrates an example pairing graphical user interface as a pairing indicator of a first portion is being moved towards a second portion of the pairing indicator.

FIG. 6 illustrates an example pairing graphical user interface including a first pairing indicator on an information handling device and a second pairing indicator on at least one additional device.

FIG. 7 illustrates an example of a pairing graphical user interface of a paired information handling device and at least one additional device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Connecting an additional device to an information handling device of a user traditionally requires a user to use a wired connection between the information handling device and the additional device. A wired connection requires a user to match available input/output components present on a device in hopes of pairing two or more devices. Finding a compatible wire for connection between devices can be frustrating since all devices do not include the same ports and/or accept the same video components. Then, when a user does find a compatible wire for connection, a user must enter into system settings and orientate device displays. In such a situation, it is common that upon connection of the devices, screen orientation needs to be adjusted, alignment may need to fixed, and/or a displaying across multiple devices may not even be permitted, for example, only a mirroring method may be allowed. Thus, even when an additional device and an information handling device seemingly should work in combination, there is no guarantee that they will. Therefore, what is needed is a system and method that permits easy connection of an information handling device to at least one additional device that does not require a user to adjust the parameters surrounding a connection.

Accordingly, the described system provides a method for pairing an information handling device and at least one additional device by use of a device pairing system. A device pairing system associated with an information handling device may receive an indication for pairing at least one device to an information handling device in use by a user. In response to receiving the indication, the device pairing system may present a graphical user interface associated with the pairing on a display of the information handling device. The graphical user interface may include displaying, on a display of the information handling device, a variety of pairing indicators for potential pairing of the information handling device to one or more additional devices. The pair indicator may include a first portion and a second portion. The device pairing system may utilize one or more pairing techniques that promotes identification and communication between an information handling device of a user and at least one additional device that may become paired.

The graphical user interface presented on the display of an information handling device may permit user interaction, for example, an ability to select and/or drag-and-drop indicators present. After presenting the graphical user interface to a user, the system may receive a pairing input based upon movement of the pairing indicator from a user at the information handling device. The device pairing system may track an input received and follow movements performed by a user on the graphical user interface. Inputs provided by a user at the system may be associated with an outlined pairing technique employed by the system and/or may be associated with performing a specific action. Receipt of the pairing input may include the information needed by the system in order to successfully perform a pairing of devices. After receiving an identified pairing input, the system may pair the information handling device with the at least one additional device, permitting the two or more devices to interface and communicate. For example, after the successful pairing, the devices may work together to expand a display and/or viewing area. Such a system and method provides an improvement over traditional multi-display pairing methods by use of a graphical user interface in combination with a pairing technique that may be easily performed by a user and does not require additional hardware components for connection.

The illustrated example embodiments will be best understood by reference to the figures. The following description is intended only by way of example, and simply illustrates certain example embodiments.

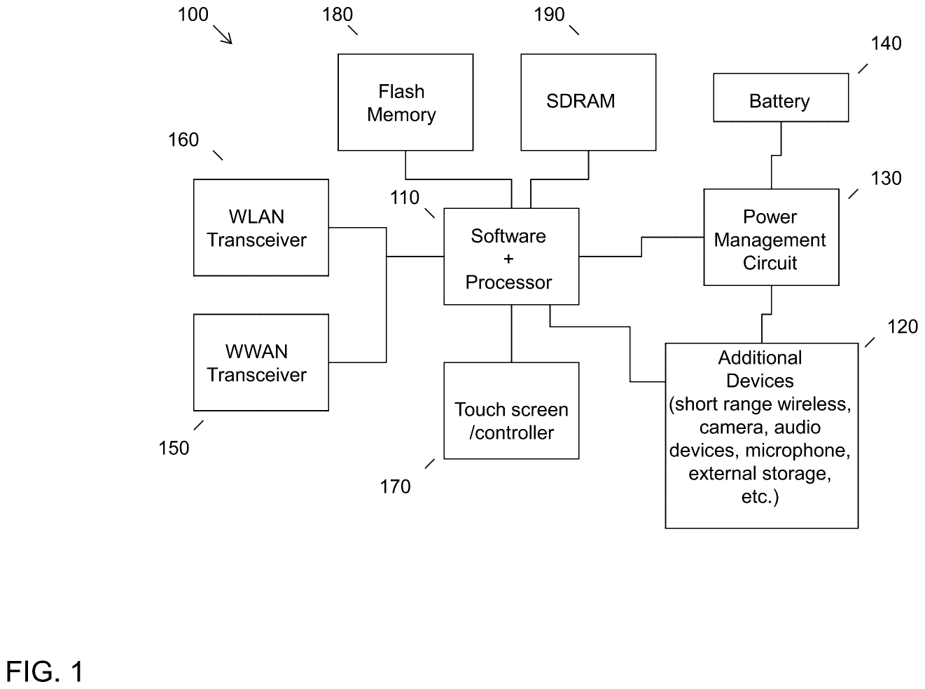

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

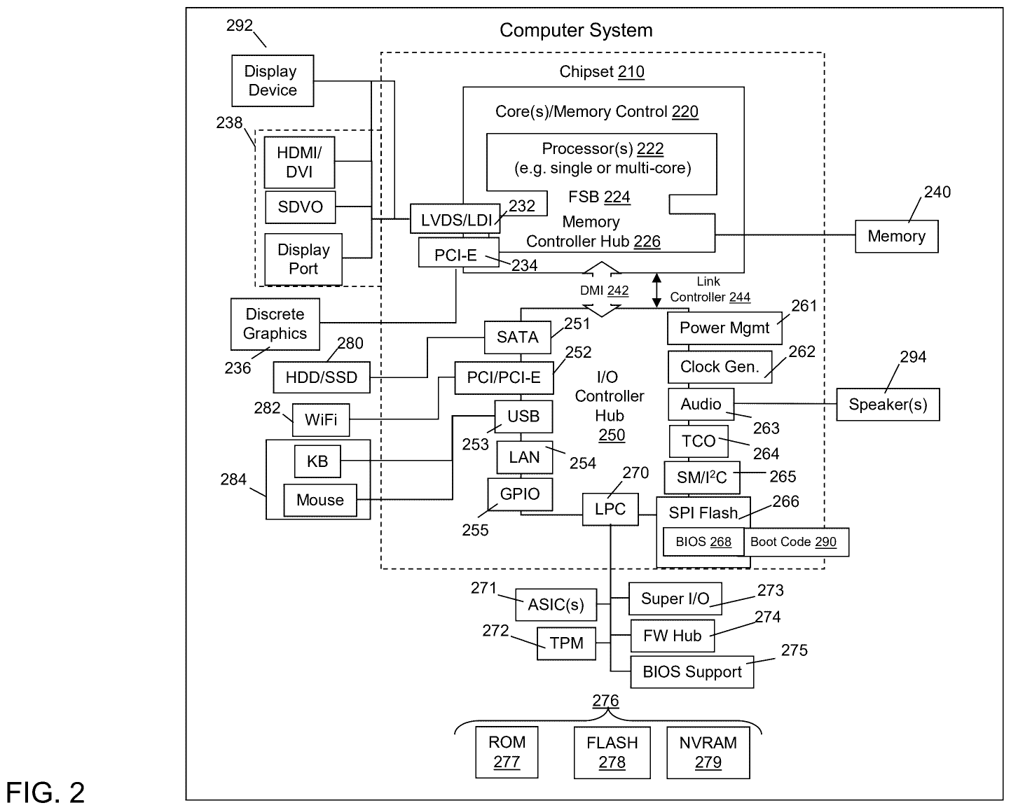

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may include devices that may be paired with each other. For example, the circuitry outlined in FIG. 1 may be implemented in a tablet or smart phone embodiment, whereas the circuitry outlined in FIG. 2 may be implemented in a personal computer embodiment.

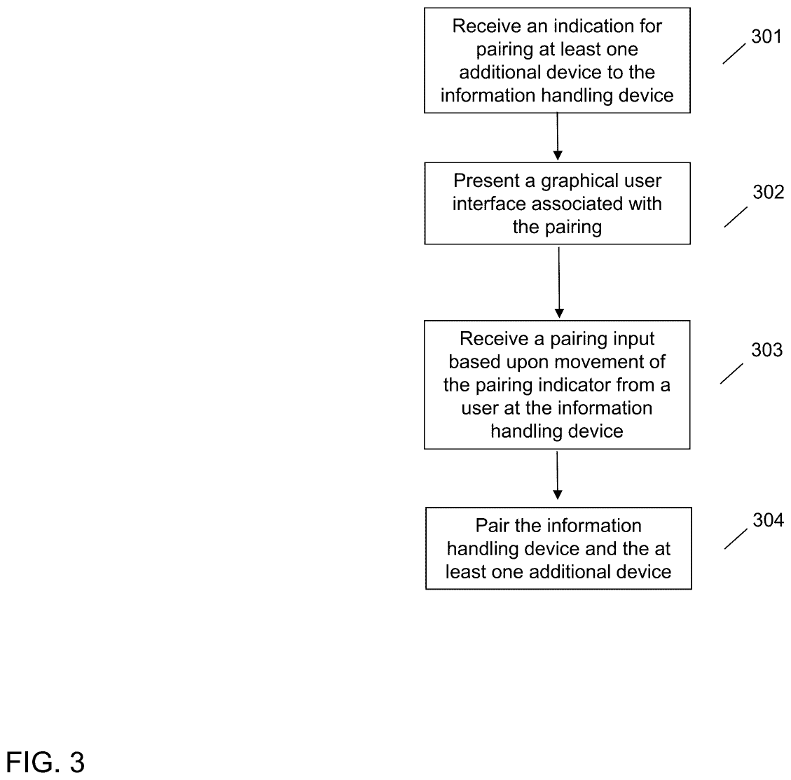

FIG. 3 illustrates an example method for pairing an information handling device and at least one additional device by use of a device pairing system. The method may be implemented on a system which includes a processor, memory device, output devices (e.g., display device, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to pair an information handling device and at least one additional device based upon a received pairing input supplied to a graphical user interface associated with a device pairing system. Additionally, the device pairing system includes modules and features that are unique to the described system.

The device pairing system may be a standalone system, may be accessible through other computing devices, and/or a combination thereof. For example, the device pairing system may be a standalone system accessed by a user and/or may be provided as an application that is accessible by a user on a computing device. The device pairing system may be accessible using any type of computing device, for example, a personal computer, laptop computer, smartphone, tablet, smartwatch, smart television, smart appliance, augmented reality device, virtual reality device, and/or the like. The device pairing system may be accessible locally using a computing device where the device pairing system is installed and/or may be accessible remotely through another computing device. However, the device pairing system may be located and operated on an information handling device to perform the described steps.

The device pairing system may utilize one or more artificial intelligence models in receiving an indication for pairing at least one additional device to an information handling device, determining when to present a graphical user interface associated with the received pairing input, when determining a pairing input is present based upon movement of a pairing indicator by a user at an information handling device, and/or the like. Artificial intelligence models may also be used for steps within a step.

For example, a model could be utilized to analyze sensors inputs to identify that an indication for pairing has been received, to determine where additional devices are located with respect to an information handling device to present a graphical user interface, to determine when a pairing input has been received, and/or the like. As another example, a model could be utilized to receive and analyze inputs regarding a location or position of at least one additional device with respect to an information handling device, identify pairing inputs related to how a user is utilizing the device pairing system, and/or the like, to pair at least one additional device to an information handling device.

For ease of readability, the majority of the description will refer to a single artificial intelligence model. However, it should be noted that an ensemble of artificial intelligence models or multiple artificial intelligence models may be utilized.

Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the device pairing system or may be a model that is created from scratch. Since the device pairing system is used in conjunction with receiving an indication for pairing, presenting a graphical user interface, and receiving a pairing input based upon movement of a pairing indicator, some models that may be utilized by the system are movement analysis models, transcript models, image analysis models, sensor input analysis models, entity identification models, similarity identification models, analysis models, filtering models, classification models, language models, large language models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machines, extreme gradient boosting, multimodal machine learning, unsupervised learning models, deep learning models, transformer models, inference models, and/or the like, including models that may be developed in the future. The chosen model structure may be dependent on the particular task that will be performed with that model.

The device pairing system may include different components for carrying out different functions of the system, including different steps to be performed. These components may be hardware components or software components. Some hardware components may include sensors (e.g., biometric sensors, image capture devices, proximity sensors, microphones, accelerometers, activity trackers, health metric sensors, etc.) that can be used to identify an indication for pairing is received, presenting a graphical user interface in response to the received indication is required, identify a pairing input is received at the graphical user interface, identify a location of an additional device with respect to an information handling device, and/or the like. Other input devices may be utilized to assist with identifying an indication-type for pairing of an information handling device to at least one additional device, determine how to present a graphical user interface, and/or the like, for example, mechanical input modalities (e.g., keyboard, mouse, etc.), touch input devices, gesture input devices, electromyography input devices, audio input devices, and/or the like. Other hardware components may be utilized to provide output from the device pairing system, for example, displays, audio output devices, haptic output devices, visual output devices, and/or the like.

One software component may include a user profile which may be unique to a user and may assist in determining when and how devices should be paired. The user profile may include user preferences. For example, the user profile may identify a default or preferred pairing location, may identify when devices should be paired, may identify what devices should be paired, may identify how or when the device pairing graphical user interface is displayed, may identify the appearance of the device pairing graphical user interface, and/or the like. The user may manually input this data into the profile or the information may be populated by the system as the system learns about the user over time. For example, the system may utilize an artificial intelligence model to learn about the user, make correlations between devices and pairing information, make correlations between pairing inputs and paired devices, and/or the like. This information can be populated within the user profile for use by the system during subsequent device pairing determinations. The user profile may also include other information about the user that seems to influence device pairing, for example, a location of use of a device and associated indications for pairing, devices that are paired based upon an environment or context of the user, how long devices are in proximity to each other before the user attempts to pair the devices, a proximity of other users during a device pairing, and/or the like.

At 301, the system may receive an indication for pairing at least one additional device to an information handling device in user by a user. A device pairing system associated with an information handling device may receive an indication for pairing using one or more device recognition and/or communication techniques. An indication for pairing may include, for example, a determination of a distance or proximity of an additional device to an information handling device, a recognition of communication between at least one device and an information handling device that has been previously established, user log-in credentials present on each device present, and/or the like.

The indication could additionally, or alternatively, be detection of devices within proximity to each other, a user pressing input mechanisms on both devices, a user providing an audible indication that the devices should be paired, a user providing a pairing gesture, and/or the like. While receipt of the indication for pairing two devices may be using traditional methods, it may also include not utilizing a menu that the user has to navigate. In other words, the described system provides an easier technique for pairing than traditional techniques that require the navigation of menus.

Receiving an indication for pairing may also include indicating to the device pairing system that devices within a relative distance or proximity to one another have been paired in the past, support a pairing across the devices, and/or the like. In some situations, a pairing of devices may not be permitted. Therefore, the device pairing system may determine, in real-time and/or continuously, whether devices present within an acceptable distance may be paired. Further, whether an additional device is identified as being in proximity to the information handling device may be based on a threshold distance. Thus, an indication for pairing may be received at a device pairing system associated with an information handling device when a threshold distance between the devices is met, within a predetermined distance, and/or the like. Alternatively, an indication for pairing at least one device to an information handling device may not be received when it is determined that devices are outside a predetermined distance of each other.

When receiving an indication for pairing has been received, an information handling device in use may display a notification of detection of a pairable additional device. A user may then elect to provide input requesting that a pairing between an information handling device and at least one additional device be performed via input to the notification, input to another graphical user input, audible input, gesture input, and/or the like. Additionally, and/or alternatively, in receiving an indication for pairing, the device pairing system may determine if a relationship between the devices currently exists and/or previously existed.

When it is determined that a relationship between devices is currently present or previously existed, a confidence associated with the pairing may be increased. Additionally, the predetermined threshold distance may also increase. In other words, a relationship between devices (e.g., user login on both devices, identification of a previous pairing of devices, devices being associated with the same user, etc.) may more easily identify and establish a potential pairing between the devices. The device pairing system may recognize and store relationships between devices that are currently ongoing and/or have been previously present, for example, in the user profile, a device profile, a data storage location associated with the device pairing system, and/or the like. Therefore, similar to current relationship between devices being present, when the system determines a previous relationship, and/or connection, between devices has occurred, the device pairing system may recognize and elevate this relationship for a potential pairing between devices. In other words, detection of devices having a current or previous relationship within proximity to each other may result in the device pairing system prioritizing the pairing of the devices over the pairing of other devices within proximity, automatically pairing the devices, and/or the like.

Receiving an indication for pairing at least one additional device to an information handling device is permitted between an information handling device and at least one additional device that are not currently connected and/or have a previous relationship. An indication for pairing such an additional device may be provided to a system, and therefore, a user of an information handling device based on one or more device identification techniques. For example, the device pairing system may recognize that an additional device within a predetermined proximity to the information handling device has an active near-field communication system, a discoverable short-range connection, and/or the like. Upon recognition of such attributes of an additional device, the device recognition system may receive an indication for pairing. This indication may also include information that a discoverable device is present at an acceptable position.

The system may also provide notifications or windows that allow easy pairing of devices. For example, the system may present a quick-read (QR) code, bar code, image, and/or the like, on one device that can be captured by another device to be paired with the device. As another example, the system may present a word, phrase, series of characters, series of images, vibrations, and/or the like, as an output (e.g., visual output, audible output, haptic output, etc.) at one device that the user can input to another device to be paired with the device.

Once an indication of pairing at least one additional device to the information handling device is received, the system may request that a user confirm or respond to a notification related to the receipt of the pairing indication. Alternatively, or additionally, the system may automatically move forward with the pairing process without requiring user input, even if the system notifies the user of the receipt of the indication. A user providing input in response to a notification may include providing input to a notification present on a display on the information handling device, providing a gesture in response to receiving an indication, providing an audible input, and/or the like. Additionally, and/or alternatively, subsequent to receiving an indication for pairing the devices, the system may automatically move to the next step of the process without waiting for user input.

In addition to the indication for pairing the devices, the system may also receive information related to a position or location of the devices with respect to each other. For example, the system may receive an indication of a relative position of the at least one additional device with respect to the display of the information handling device. The relative position may indicate what side of the display of the information handling device the additional device is located at. For example, the relative position may identify the additional device is located on a left side of the information handling device display, on a right side of the information handling device display, at a top side of the information handling device display, at a bottom side of the information handling device display, and/or the like. As noted, this is a relative position. Thus, while the system may receive more accurate position information, the system may ignore the portions of the position information that is not important. For example, the system may identify that the additional device is not only located on the right side of the information handling device display, but also is located slightly behind the information handling device display. For the purposes of the pairing indicator, the information related to being behind the information handling device display is not important and may be ignored.

Whether a user provides input in response to receiving an indication for pairing the devices, and/or a system automatically responds to the received indication, the device pairing system may continue on to present a graphical user interface (GUI) associated with the pairing between at least one additional device and the information handling device at 302. Thus, on the display of the information handling device and in response to receiving the indication 301, the device pairing system may present a graphical user interface (GUI) to a user at 302. For ease of readability, the information handling device is the device to which an additional device is being paired. In other words, the information handling device refers to the device that is treated as the primary device. The additional one or more devices are any devices that are treated as the secondary device. The primary device and secondary devices can change between pairings, be identified by a user in the user profile, may be learned by the system over time, may be based upon characteristics of the devices, may be identified by the user at the time of pairing or receipt of the pairing indication, and/or the like. Thus, the primary device does not have to be the largest device, the most stationary device, the most used device, and/or the like.

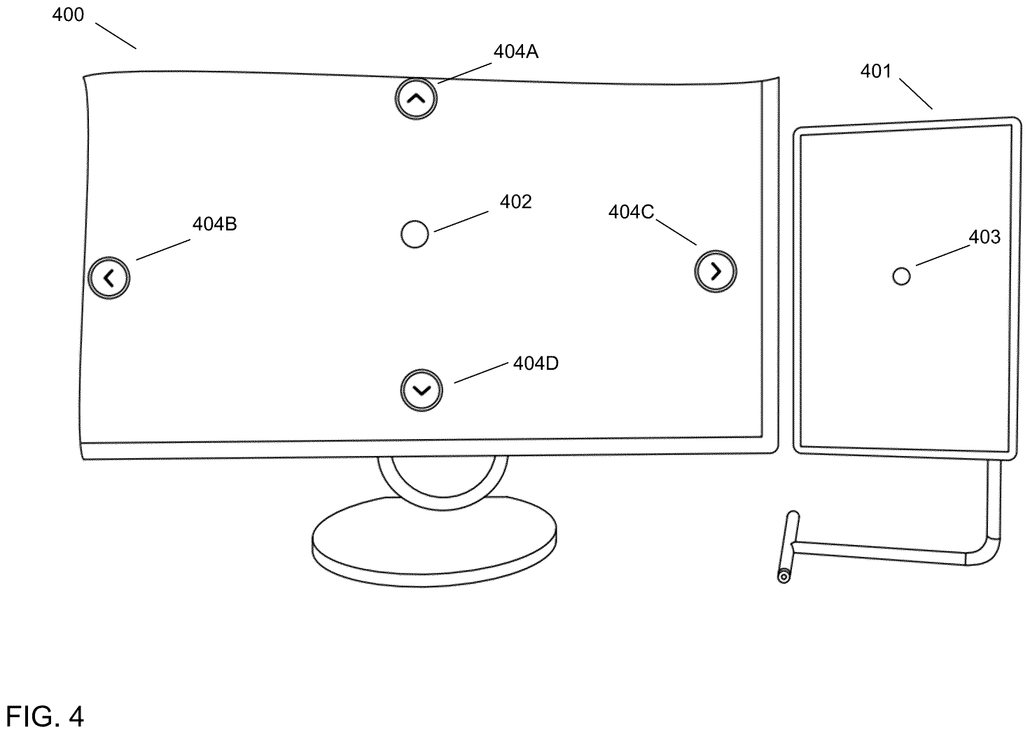

The GUI may provide an interactive interface on an information handling device for easy connection between the information handling device and the at least one additional device. Pairing indicators may be presented on each device that is being connected. The pairing indicators may have multiple pairing portions, particularly, but not limited to, on the information handling device display. On the display of the information handling device, the display may include a pairing indicator initially present at the center of a GUI, for example, as illustrated and as discussed in more detail in connection with FIG. 4 at 402. This pairing indicator 402 on the information handling device 400 may also act as the first portion of the pairing indicator. Additionally, when presenting a graphical user interface, the system may display a plurality of second portions of the pairing indicator 404A-404D. The plurality of second portions of the pairing indicator 404A-404D may be located around the edge, and/or perimeter, of the display of the information handling device. However, the location of these can vary.

These second portions of the pairing indicator may also be referred to as directional indicators because of an affiliated location of an additional device in relation to a position of the information handling device. In other words, the second portions of the pairing indicator may be located in a position on the information handling device display that would be associated with a possible relative position of an additional device. Thus, the second portions may indicate the relative position of the additional device.

These second portions may also provide an indication of where the additional device has been detected. For example, second portions associated with a relative position of an additional device may be open or selectable, whereas second portions associated with positions where an additional device has not been detected may be closed or non-selectable.

As the system continues presenting a graphical user interface, an additional device that may be pairing to the information handling device may also present a portion of the GUI. The additional device may display a second pairing indicator 403 on a display of the additional device 401. Similar to the pairing indicator present on the information handling device of the user, the second pairing indicator displayed the at least one additional device may be initially located at a center of the display of the device. However, unlike the presentation of the GUI at the display of the information handling device, the at least one additional device may not include a plurality of second portions, and/or directional indicators, of the second pairing indicator. However, this setup for pairing indicators is merely illustrative and other configurations, including numbers of indicators, shapes of indicators, location of indicators, and/or the like, are contemplated and possible.

When presenting a graphical user interface associated with a pairing, the device pairing system may employ one or more display alternating and/or locking techniques. The system may utilize a technique that may save, lock, and/or disable interaction with information present on a display prior to presenting the GUI. One technique that may be utilized is presenting a blurred overlay across a desktop or input area on the display of the information handling device and presenting the graphical user interface over the blurred overlay. A blurred overlay may prevent interactions with information present behind the overlay, for example, windows and/or applications in use, and further permit interacting with the graphical user interface without influencing what is present behind the blurred overlay. A blurred overlay may remove a clear focus on a display, therefore, clearly presenting the GUI to a user via the display of an information handling device. Additionally, the technique utilized, for example, the blurred overlay, may also be present on the at least one additional device. This blurring may occur when a communication between the information handling device and the additional device is established or may occur after the pairing of the devices. This may additionally assist in indicating to the user what devices are being paired during a particular pairing session.

Once the graphical user interface is presented, the device pairing system may receive, from the user, a pairing input based upon movement of the pairing indicator at the information handling device at 303. The graphical user interface may receive a pairing input from a user indicating how a user prefers to pair the information handling device and the at least one additional device. In other words, the pairing input indicates how the displays of the devices are to be treated with respect to each other and, more specifically, how the displays should be located with respect to each other. A relative position of the at least one additional device may be an indicator for how pairing between devices may occur since a location of an additional device in relation to the location of the information handling device may identify a desired display location. Therefore, movement of the first portion of the pairing indicator on the information handling device to a second portion of the pairing indicator associated with the relative position of the additional device, may indicate that the displays should be paired and thereafter configured with respect to each other. In other words, for example, if an additional device is located on the right side of the information handling device, a user may most likely provide an input to pair with the additional device through a second portion of the pairing indicator located on the right side the display of the information handling device.

However, it should be noted that the user may want to the configuration of the displays with respect to each other to be different and could, therefore, provide movement of the first portion of the pairing indicator to a different of the second portions of the pairing indicator to cause the desired configuration. For example, using the example of the additional device being located on the right side of the information handling device, if the user wants the additional device display to be configured so that it appears above the information handling device display, the user could move the first portion of the pairing indicator to the second portion of the pairing indicator that is located at the top side of the information handling device display. In this example, the additional device display would then work as if it were located above the information handling device display even though it is physically located to the right side of the information handling device display.

When receiving a pairing input based upon a movement of the pairing indicator, the device pairing system may receive the pairing input based upon a user selection. Using the example illustrated in FIG. 4-FIG. 7, a user may first select the first portion of the pairing indicator present at the center of the display 402 and/or GUI on the information handling device. This selection of the first portion of the pairing indicator 402 may then instruct the GUI to provide output back to the user indicating the relative position of the at least one additional device. The indication being provided back may be, for example, a visual indication of at least one of a second portion of the pairing indicator (e.g., highlighting and/or pulsating a directional indicator associated with the relative position of the additional device, changing the color of the directional indicator, etc.), an audible indication of at least one of a second portion of the pairing indicator (e.g., playing a tone identifying which directional indicator is associated with a relative position of an additional device, saying a word corresponding to the directional indicator associated with the relative position of the additional device, etc.), and/or the like. Thus, upon the initial selection of the first portion of the pairing indicator, the graphical user interface may assist a user with identifying which of the second portions of the of the pairing indicator may be the most logical for selection of the pairing. However, the user could choose any of the second portions for pairing the additional device.

Receiving a pairing input based upon movement of the pairing indicator may include the device pairing system detecting movement of a first portion of the pairing input to one of a plurality of second portions of the pairing input. As mentioned previously, the first portion of the pairing input coincides with the pairing indicator originally centered on the display of the information handling device. When detecting movement of the first portion of the pairing input to one of a plurality of second portions on the pairing input, the system may determine, after the initial selection of the first portion, which second portion, and/or directional indicator, the user may select for pairing. The movement may include double clicking a second portion, a drag-and-drop method onto a second portion, and/or the like. Movement of a first portion may be performed utilizing any selection technique. For ease of understanding, reference to a drag-and-drop method may be referred to herein; however, this is intended as a non-limiting example.

The first portion of the pairing input based upon the movement received at the information handling device may then overlap with one of the second portions and/or combine the first and second portions into a single indicator. A user may select the pairing indicator, and/or first portion of the pairing input, and drag this pairing indicator to a desired second portion of the pairing input, and/or a directional indicator. Upon overlapping the first and second portions of the pairing input and deselecting the first portion, the device pairing system may establish a connection between the information handling device and the at least one additional device in a direction associated with the selected second portion. Then, based upon the received pairing input, the device pairing system may pair the information handling device at the at least one additional device at 304.

Pairing the information handling device and the at least one additional device 304 includes connecting the display of the information handling device and a display of the at least one additional device. In other words, the pairing includes allowing communication between the information handling device and the at least one additional device. Additionally, the display screens of the information handling device and the additional device may work together as a single input area, may work as a multiple monitor setup, and/or the like.

Discussed hereinafter in is an example system and method for pairing an information handling device and at least one additional device. Referring to FIG. 4, an example graphical user interface as initially presented on an information handling device is provided. As can be seen in FIGS. 4, 400 is a display of an information handling device and 401 is a display of the at least one additional device. Throughout the description of the following figures, a pairing of one additional device to an information handling device is disclosed; however, it is important to remember that this is a non-limiting example and that such a system and method may be applied to the pairing of a plurality of devices to an information handling device.

After receipt of an indication for pairing a device 401 to an information handling device 400, the device pairing system may present a graphical user interface, for example, as illustrated in FIG. 4. In the center of the information handling device display 400 is the first portion of the pairing indicator 402. Additionally, multiple second portions of the pairing indicator 404A, 404B, 404C, and 404D are present and located along the edge, or a perimeter, of the information handling device 400. Each of the second portions of the pairing indicator 404A, 404B, 404C, and 404D may be also known as directional indicators. Then, present on the additional device 401, a second pairing indicator associated with the additional device 401 is present. This is a baseline example of how a graphical user interface may be presented across multiple devices having a relationship prior to being paired. Such an illustration may be viewed subsequent to receiving an indication for pairing devices.

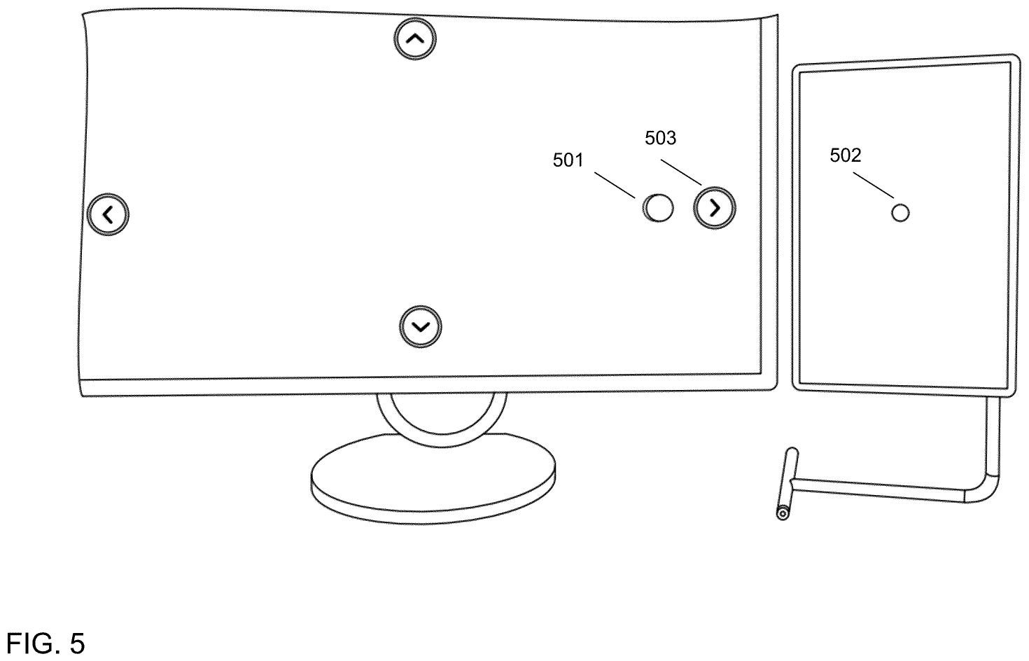

Moving onto FIG. 5, it can be seen the first portion of the pairing indicator 501 has been moved or is being moved to one of the second portions of the pairing indicator 503 on the display of the information handling device. As mentioned previously, and intended as a non-limiting example, a drag-and-drop method may be utilized and the device pairing system may recognize this movement as receiving a pairing input at the graphical user interface present on the information handling device.

The pairing indicator 501, or first portion of the pairing indicator, is being moved towards the second portion of the pairing indicator 503 in an attempt to pair the additional device having a relative location of being to the right of the information handling device to the information handling device. The second pairing indicator 502 present on the additional device remains centered until a pairing of the devices is established.

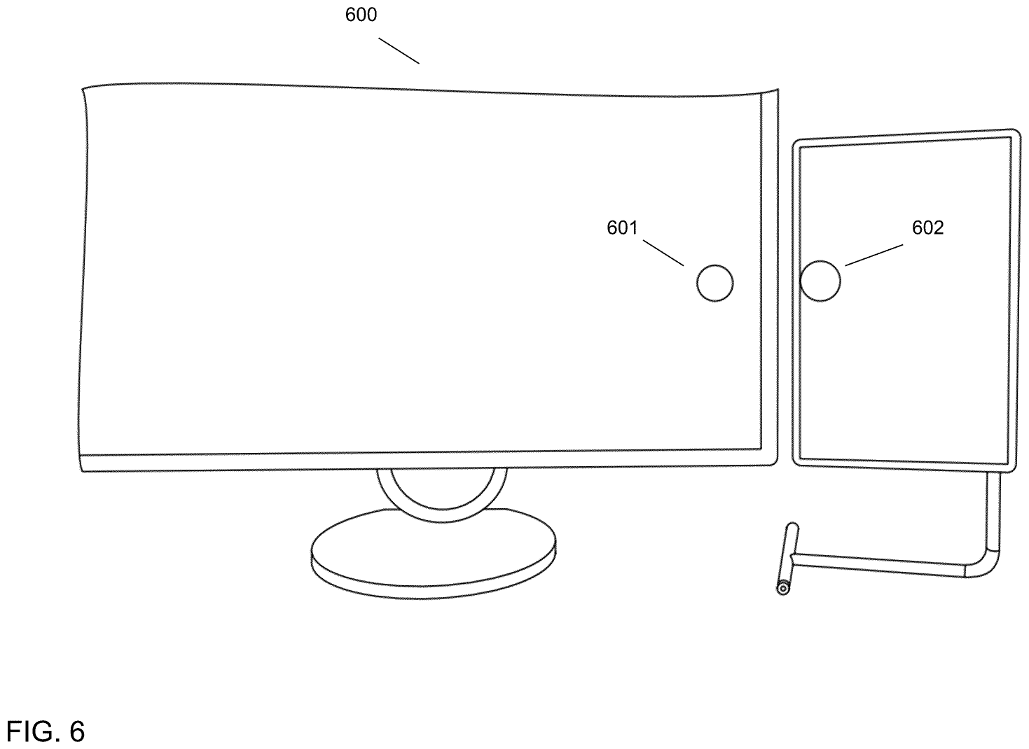

When it is determined that the first portion of the pairing indicator and the second portion of the pairing indicator have been overlapped, connected, or otherwise that the user is intending to pair the two devices, the first pairing indicator on the information handling device 601 and the second pairing indicator on the additional device 602 may move towards each other, as illustrated in FIG. 6. Once paired, the devices establish a connection and may operate as a single display 600. The first portion and the second portions of the indicator present on the display of the information handling device may coincide, and/or become one image, shape, etc., along the edge of the information handling device closest position to the relative position of the additional device. This creates pairing indicator 601. Similar to the positioning of indicator 601 on the display of the information handling device, the position of the second pairing indictor 602 on the display of the additional device may be located on an edge closest in position to the relative position of the information handling device. Therefore, pairing indicator 601 and second pairing indicator 602 are located at the edge of their display closest in position to their paired counterpart. This allows the user to understand how the devices will be paired and the displays will be configured with respect to each other.

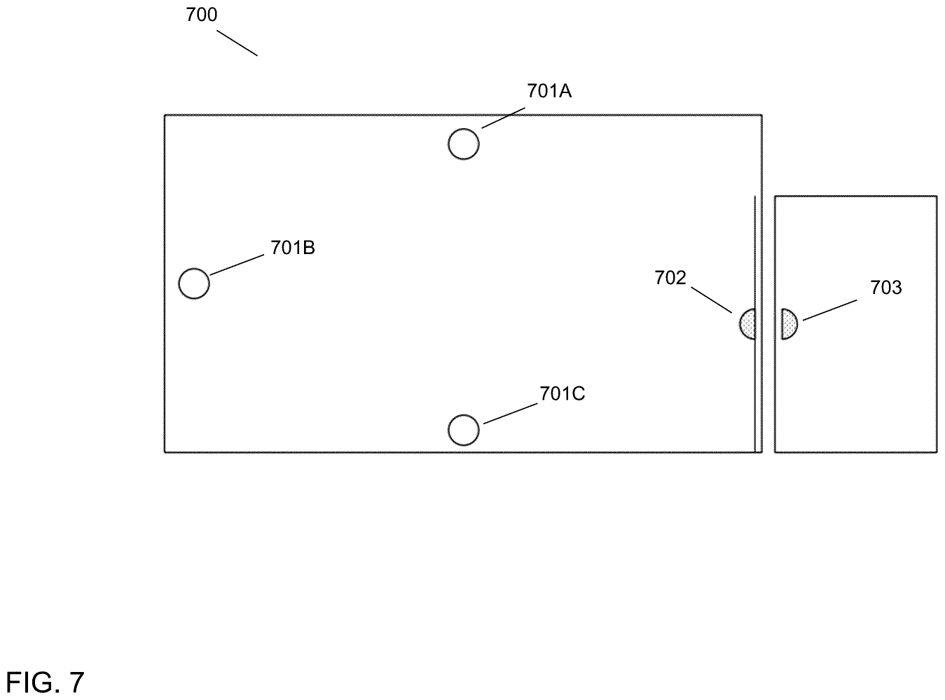

Referring now to FIG. 7, an example of a graphical user interface of paired information handling device and at least one additional device is provided. This illustration provides what a graphical user interface may look like with an already connected additional device. The paired devices acting as a single display 700 may include second portions of the pairing indicator 701A, 701B, and 701C. These second portion indicators, and/or directional indicators, are still available for connection to an additional device. This is made clear by, for example, illustrated indicators lacking color, including a full shape, a lack of device in a relative position, and/or the like. Additionally, pairing indicator 702 on the display of the information handling device is present at the edge of the display and includes a variety of shape components indicating that a connection is present, for example, 702 includes a color describing a pairing over the indicator, a half shape indicator, and/or a location closer to the edge of the display of the information handling device. The corresponding second indicator 703 may have the same characteristics as the first indicator 702 so that a user can easily see what devices are paired and where. These illustrative examples for indicator availability are non-limiting, and a system and method may utilize a variety of methods illustrating availability and/or may elect to not show any characteristic distinctions.

The various embodiments present herein provide an improvement over traditional methods for pairing an information handling device to at least one additional device having a display. Rather than requiring a user to access system settings and/or hardwire an additional device to an information handling device, the described system and method provides a graphical user interface that may permit easy pairing based upon an established wireless relationship between devices. A user may access a graphical user interface in response to receiving an indication for pairing, and rather than a user needing to make manual adjustments to system settings and/or requiring wires and the appropriate connection types to utilize an additional device, the current system and method may wirelessly connect any compatible additional device to an information handling device in use.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more”unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
selectively pairing, utilizing a device pairing system of an information handling device, at least one additional device to the device pairing system; and
displaying, at a graphical user interface of the information handling device configured to display a pairing input, the pairing input from the at least one additional device over a blurred overlay portion of the graphical user interface.

2. The method of claim 1, wherein the selectively pairing input comprises receiving an indication of a relative position of the at least one additional device with respect to the display of the information handling device.

3. The method of claim 2, wherein the receiving the indication of a relative position comprises receiving movement of the pairing indicator to a position on the display of the information handling device corresponding to the relative position of the at least one additional device.

4. The method of claim 1, wherein the displaying the pairing input comprises displaying a pairing indicator that comprises displaying a first portion of the pairing indicator and a plurality of second portions of the pairing indicator, wherein the second portion of the pairing indicator indicates the relative position of the at least one additional device.

5. The method of claim 1, wherein the displaying the pairing comprises displaying a second pairing indicator on a display of the at least one additional device.

6. The method of claim 1, wherein the selectively pairing comprises automatically activating the graphical user interface when the at least one device is determined to be within a threshold distance of the information handling device.

7. The method of claim 1, wherein the selectively pairing comprises detecting movement of a first portion of the pairing input to one of a plurality of second portions of the pairing input.

8. The method of claim 1, wherein the pairing comprises connecting the display of the information handling device and a display of the at least one additional device.

9. The method of claim 1, comprising, providing, within the graphical user interface, an indication of the pairing.

10. (canceled)

11. A system, the system comprising:
a processor;
a memory device operatively connectable to the processor and configured to store, execute, and send instructions via system hardware to a graphical user interface;
a device pairing system configured to selectively pair at least one additional device to the system; and
the graphical user interface configured to display a pairing input from the at least one additional device over a blurred overlay portion of the graphical user interface.

12. The system of claim 11, wherein the selectively pairing comprises receiving an indication of a relative position of the at least one additional device with respect to the display of the information handling device.

13. The system of claim 12, wherein the receiving the indication of a relative position comprises receiving movement of the pairing indicator to a position on the display of the information handling device corresponding to the relative position of the at least one additional device.

14. The system of claim, wherein the displaying the pairing input comprises displaying a pairing indicator that comprises displaying a first portion of the pairing indicator and a plurality of second portions of the pairing indicator, wherein the second portion of the pairing indicator indicates the relative position of the at least one additional device.

15. The system of claim 11, wherein the displaying the pairing comprises displaying a second pairing indicator on a display of the at least one additional device.

16. The system of claim 11, wherein the selectively pairing comprises automatically activating the graphical user interface when the at least one device is determined to be within a threshold distance of the information handling device.

17. The system of claim 11, wherein the selectively pairing input comprises detecting movement of a first portion of the pairing input to one of a plurality of second portions of the pairing input.

18. The system of claim 11, wherein the pairing comprises connecting the display of the information handling device and a display of the at least one additional device.

19. The system of claim 11, comprising providing, within the graphical user interface, an indication of the pairing.

20. A product, the product comprising:
a processor;
a memory device operatively connectable to the processor and configured to store, execute, and send instructions via system hardware to a graphical user interface, wherein the memory device comprises a computer-readable storage that stores executable code;
a device pairing system configured to selectively pair at least one additional device to the system; and
the graphical user interface configured to display a pairing input from the at least one additional device over a blurred overlay portion of the graphical user interface.
